(19) United States
(12) Patent Application Publication
(10) Pub. No.: US 2002/0165805 A1
(43) Pub. Date: Nov. 7, 2002

(54) Method and system for managing parts requirements processes

(75) Inventors: Andrew Varga, Poughkeepsie, NY (US); Ernest Burger, Highland, NY (US); Ghassan Chidiac, Wappingers Falls, NY (US); Giancarlo Paleschi, Highland, NY (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, Armonk, NY

(21) Appl. No.: 09/847,557

(22) Filed: May 2, 2001

(51) Int. Cl. G06F 17/60

(52) U.S. Cl. 705/28

(57) ABSTRACT

The bill of material assist tool overcomes or alleviates the shortcomings of the prior art by providing a method and system for managing parts requirements processes, including generating detailed bills of material with key information necessary for component selection and generation and which indicates multiple sources for those components. The system includes a host system including a workstation; a server; a network connection for allowing the workstation and server to communicate; and a storage device coupled to the workstation. The system also includes a data storage device housing databases of parts information, procurement information, computer-aided drafting information, approved vendors lists, and bill of material files. One or more of these databases may be supplemented with or substituted by commercially provided databases and/or applications. The commercially provided databases and/or applications are provided via a network connection with enterprise 101 such as an Internet, extranet, or virtual private network. The bill of material assist tool allows users to collect and view parts data from a multitude of sources and make faster purchasing and design decisions for electronic card designs.

### BACKGROUND

The present invention relates to parts requirements processes, and more particularly, the present invention relates to a system and method for managing parts requirements processes for electronic card designs.

Common planning systems such as Product Design and Development, Product Lifecycle Management, Materials Requirements Planning (MRP) and Manufacturing Resource Planning systems assist manufacturing enterprises with designing and engineering new products and generating requirements for materials, parts, and subassemblies that are established on their bills of material (BOMs) for these products. A BOM is a list of parts or components required for the assembly of a specified product and includes descriptive information pertaining to the parts, as well as quantities needed and pricing information.

Effective planning systems are particularly important to the electronics industry. In today's global economy, particularly with respect to computer technology, life cycles and prices related to electronics such as personal computers, PDAs, cellular telephones, etc., have dramatically declined over the last ten years. Further, the growth of e-commerce on the Internet creates additional pressures on this industry as traditional geographic barriers are broken down and new businesses/competitors are entering the market. In order to stay competitive, these market dynamics require electronics businesses to develop and introduce new products faster and cheaper than the competition. To meet this demand, new and enhanced business solutions are critical.

One problem the electronics engineering industry is facing today is the increasing difficulties in acquiring parts or components needed for a product design. Locating specific parts can be a difficult task for engineers and procurement specialists where numerous suppliers market hundreds of different parts, many of which are identified by internally-assigned or unique part numbers or descriptions and stored in proprietary databases. Prices and quality are also factors which must be addressed in selecting a part and/or supplier. Further, parts data are often stored in formats not compatible with a purchasing manufacturer's legacy system.

Commercial providers offer point solutions attempting to resolve some of these inefficiencies, however, none exist which can aggregate disparate part data from various sources, then organize and present the data to a user in a single view for comparison and selection. Existing electronic computer-aided drafting (ECAD) applications in the engineering community, such as Cadence(TM) and Viewlogic(TM) do not provide key information required for component selection and generation of a detailed bill of material, for instance, indicating more than one source of a designated part. In current design systems, relevant part information that is otherwise not available must be communicated via e-mail and hard copy documents. Spreadsheets can be used to aggregate and edit bills of material to create the detailed level of completion required, however, this alternative is not as efficient as it is tedious and time consuming to implement and maintain.

What is needed therefore, is a process for facilitating the parts requirements processes by aggregating key information relating to component selection and generation of detailed bills of material from multiple sources of the designated component and which can be provided to a user in a single view, as well as selectively downstreamed to users from other departments or locations.

### SUMMARY

The bill of material assist tool overcomes or alleviates the shortcomings of the prior art by providing a method and system for managing parts requirements processes, including aggregating key information necessary for component selection and generation from multiple sources, generating a complete and accurate bill of material from this information, and selectively downstreaming this information to necessary individuals or departments. The system includes a host system including a workstation; a server; a network connection for allowing the workstation and server to communicate; and a storage device coupled to the workstation. The system also includes a data storage device housing databases of parts information, procurement information, computer-aided drafting information, approved vendors lists, and bill of material files. One or more of these databases may be supplemented with or substituted by commercially provided databases and/or applications. The commercially provided databases and/or applications are provided via a network connection with enterprise 101 such as an Internet, extranet, or virtual private network. The bill of material assist tool allows users to collect and view parts data from a multitude of sources and make faster purchasing and design decisions for electronic card designs.

### BRIEF DESCRIPTION OF THE DRAWINGS

FIG. 1 is an exemplary block diagram of a portion of a network system upon which the bill of material assist application is implemented;

FIGS. 2A and 2B are flowcharts describing the bill of material assist process in a design or engineering community;

FIG. 3 is an exemplary computer screen window illustrating BOM data imported from a user file into the bill of material assist application;

FIG. 4 is an exemplary computer screen window illustrating a single view of various component data aggregated by the bill of material assist application from multiple sources;

FIG. 5 is an exemplary BOM notification delivered via the bill of material assist application to a parts procurement department for action; and

FIG. 6 is an exemplary computer screen window illustrating a BRS-modified bill of material assist file for review by a designer.

### DETAILED DESCRIPTION OF THE PREFERRED EMBODIMENT

The bill of material assist tool improves the parts requirements management process for card assemblies by providing early visibility of parts supply statuses which enable manufacturing enterprises to improve production planning processes, collect and view part number data from disparate design applications and parts databases via a bridging component, and streamline the flow of information for BOM review among planning, procurement and engineering departments within an enterprise.

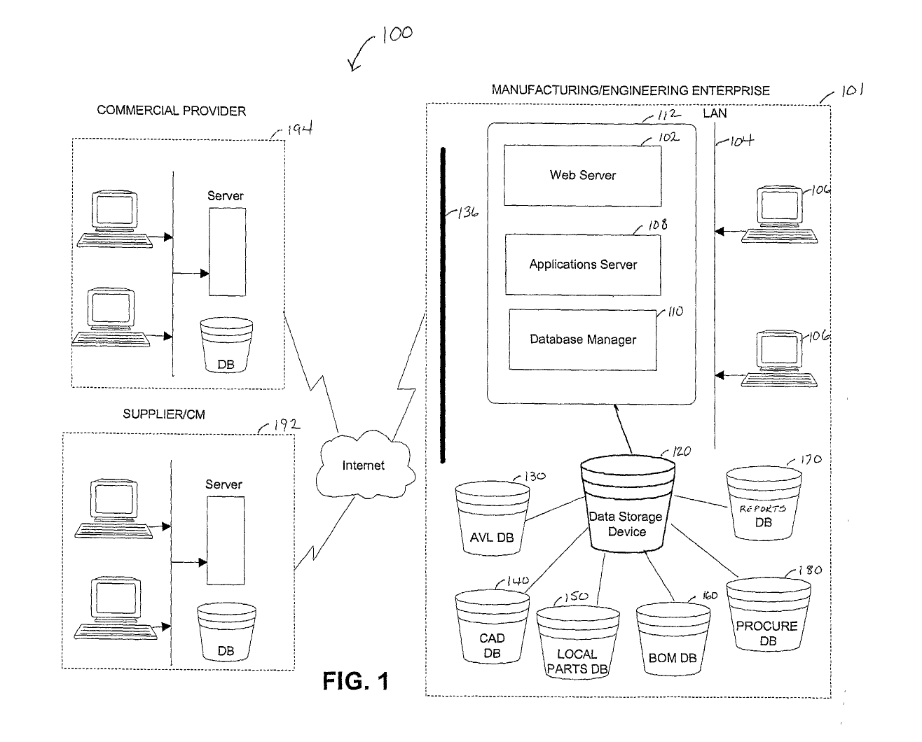

In terms of structure, reference is now made to FIG. 1. Therein depicted is a block diagram representing a network system 100 for implementing the bill of material assist tool of the present invention. System 100 includes an enterprise 101 comprising a web server 102 that is located on host system 112 and connected through a network 104 to terminals 106. Network 104 may comprise a LAN, a WAN, or other network configuration known in the art. Further, network 104 may include wireless connections, radio based communications, telephony based communications, and other network-based communications. Applications server 108 and database manager 110 are also located on host system 112 and are in communication with web server 102 and network 104. Any web server software or similar program that handles general communications protocols and transport layer activities could be used as appropriate for the network protocol in use. A firewall 136 or other security device limits access to enterprise 101 to network users with proper authorization.

Host system 112 may include an IBM® S/390 system or other suitable computer system. Host system 112 is running web server software designed to accommodate various forms of communications, including voice, video, and text. For purposes of illustration, host system 112 is running Lotus Domino(TM) and Lotus Notes (TM) as its groupware applications software, however, any compatible e-mail-integrated, web-enabled collaborative software could be used. Applications server 108 executes the bill of material assist application of the present invention. The bill of material assist application may be one of many business applications employed by enterprise 101 which, in combination, constitute its Enterprise Resource Planning and Materials Requirements Planning suites. Examples of applications running on applications server 108 include: a procurement application, one or more CAD applications, a parts information application, a bridging application for integrating disparate parts data and communicating with external entities, and a reporting application for analyzing, organizing, and summarizing the various data received by host system 112. These applications are discussed further herein.

Data storage device 120 is included in system 100. and comprises any form of mass storage device configured to read and write database type data maintained in a file store (e.g., a magnetic disk data storage device). Of course, it will be appreciated that data storage device 120 may be one that consists of multiple disk sub-systems which may be geographically dispersed and coupled via network architecture. There is no positive requirement that data storage device 120 be maintained in one Ifacility; to the contrary, the volume of information stored therein may dictate geographical dispersion and the like. All that is required is that data storage device 120 be logically addressable as a consolidated data source across a distributed environment such as a network system. The implementation of local and widearea database management systems to achieve the functionality of data storage device 120 will be readily understood by those skilled in the art. Information stored in data storage device 120 is retrieved and manipulated by database manager 110. For purposes of illustration, database manager 110 is utilizing IBM's DB/2® software.

Data storage device 120 provides a repository for a library of documents created and used by the bill of material assist tool. Databases 130-180 associated with data storage device 120 house a variety of information including approved vendors lists (AVLs) 130, CAD libraries and tools 140, parts information 150, BOM files 160, procurement data 180, and records pertaining to user profiles and miscellaneous reports 170 required by enterprise 101.

System 100 may also include a commercial database provider 194 and/or tools accessed over the Internet or other network connection. A commercial database such as Aspect Explore (TM), which provides parts information services, may be used supplementary to host system's 112 parts database 150. Other commercial databases available to host system 112 include procurement applications such as Procurement Contracts Management System (TM) and summary and reporting applications such as Brio (TM). Commercial libraries or Library Information Management Systems (LIMS) relating to CAD tools and services are well known in the art and may also be utilized by host system 112 if desired. Further, services of these types may be offered to host system 112 by an Applications Service Provider (ASP) under a contractual arrangement.

System 100 also includes supplier, contract manufacturer, or trading partner 192 for communicating various information pertaining to a bill of material, order status and tracking, and engineering changes which involve the particular supplier 192. Data transmitted within enterprise 101 and between enterprise 101 and supplier 192 is facilitated by business applications and bridging devices such as those described in the following patent applications: “Parts Requirement Planning System and Method Across an Extended Supply Chain” disclosed in

U.S. patent application Ser. No. 09/730,683, filed on Dec. 6, 2000; “Method and System for Facilitating Parts Procurement and Production Planning Processes Across an Extended Supply Chain” disclosed in U.S. patent application Ser. No. 09/757,070, filed on Jan. 8, 2001; and “E-Collaboration Commodity Management System and Method” disclosed in U.S. patent application Ser. No. 09/658,257, filed on Sep. 8, 2000, all of which are incorporated herein by reference in their entireties. Both supplier 192 and commercial service provider or database 194 may be in communication with enterprise 101 via the Internet, extranet, or via a virtual private network (VPN) connection.

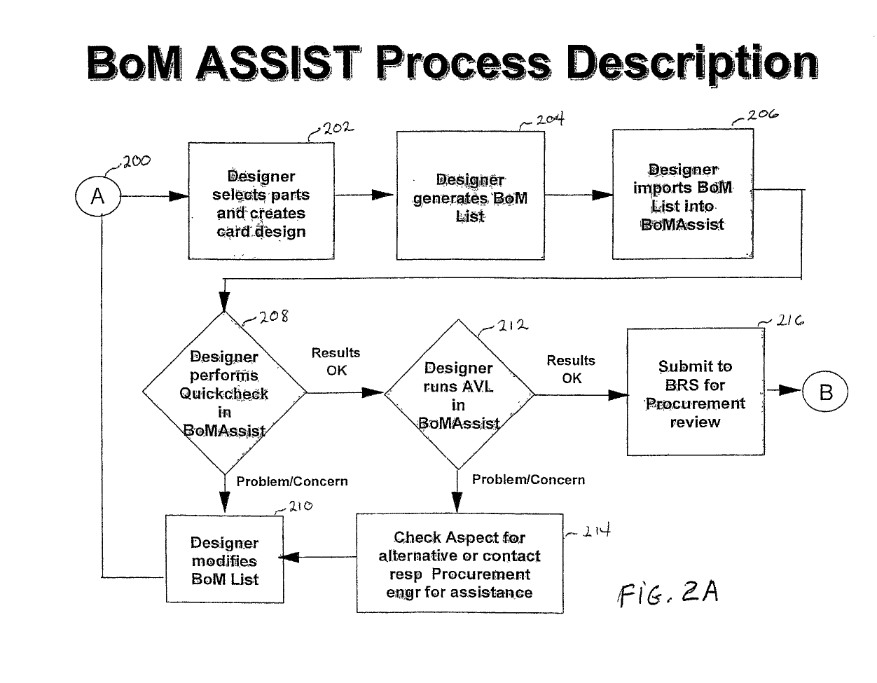

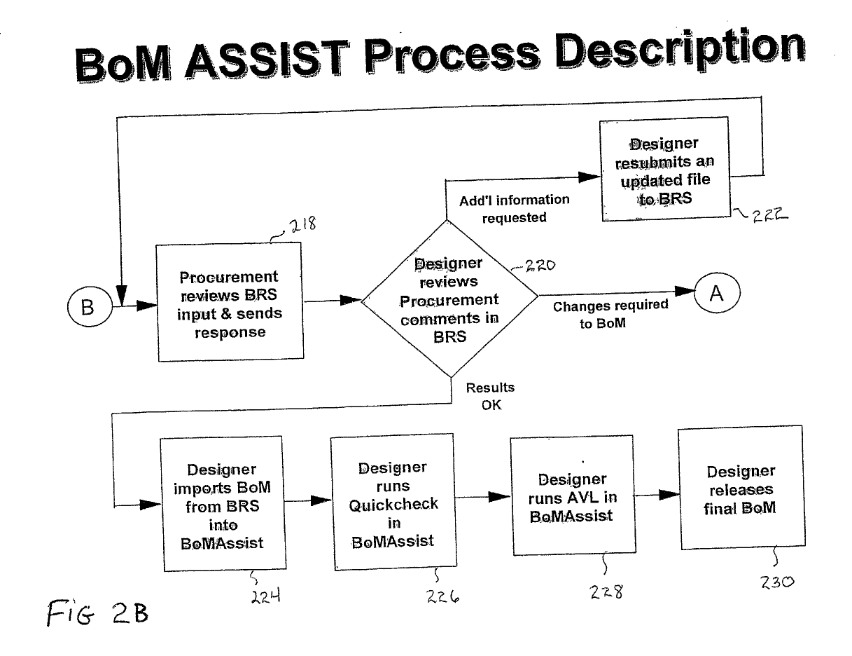

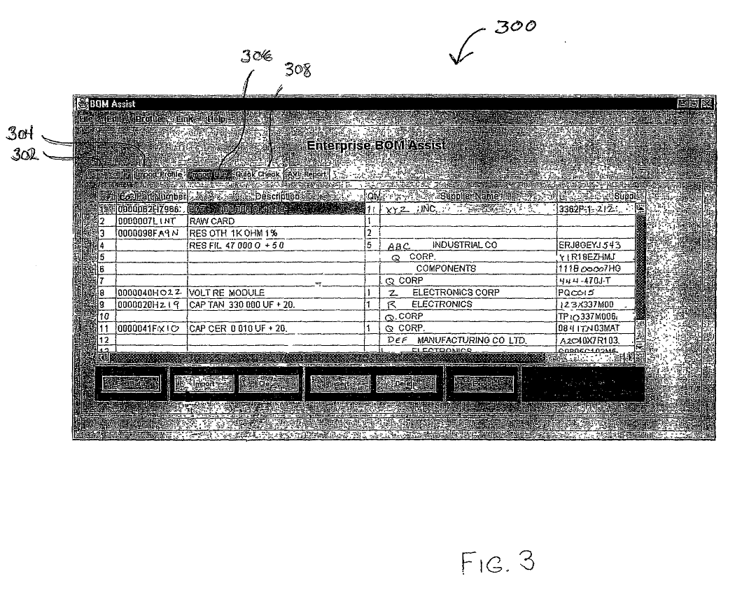

FIGS. 2A and 2B illustrate the bill of material assist process as executed by a user such as a designer or engineer beginning at step 200. A designer selects component parts and creates a card design at step 202. From this list of component parts, the designer generates a BOM list at step 204 and saves it into an input file or user's file at workstation 106. The designer then accesses the bill of material assist application by logging in and entering profile data, such as a password and user identification at step 206. This may be accomplished by selecting the user profile tab 302 shown in FIG. 3. Once permitted access to the bill of material assist application, the designer selects import profile 304 also shown in FIG. 3 whereby the bill of material assist application maps the order of the data entries in the input file or user's file (i.e., the original BOM data file) to specific bill of material assist data fields used by the application. The designer describes to the bill of material assist application which column in the input file contains the locally-assigned part number (i.e., proprietary identifier), which column in the input file contains the description, etc. The designer then selects the import file tab 306 of FIG. 3 which initiates the import of the data in the user's file into the proper fields in the bill of material assist application. Once completed, the imported data is reflected in the appropriate bill of material assist fields as shown in FIG. 3.

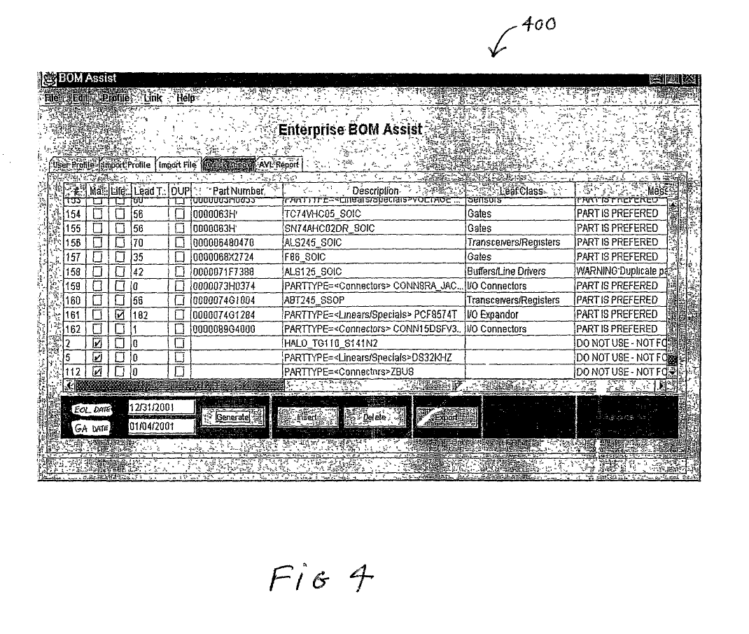

The designer next selects the Quick Check tab 308 at step 208 which is a component of the bill of material assist application that provides a user with a view of additional information relevant to a part selection process such as lead time, current supply status (e.g., constrained or on allocation), single or multiple rsources, end-of-life date, preferredness, and other information not available in a typical CAD model library and as shown in FIG. 4. The bill of material assist application aggregates information from multiple sources for each part number on a BOM and offers a concise summary view for the user as described herein. For each line entry listed on quick check screen 400 of FIG. 4, information provided includes the following information.

Map flag. The map flag field is used to reflect where the bill of material assist application has attempted to locate a local part number in the commercial parts database based upon a supplier's name and supplier part number provided. This is shown by a check mark. If successful, the local part number field will be populated. If unsuccessful, the field is left blank. The absence of a check mark indicates that a local part number was originally provided for the line item and that the bill of material assist tool accepted it as valid.

Life Cycle. This column indicates with a check mark that bill of material assist tool has identified an inconsistency with either the lead time for the part exceeding the general availability date for this design if or an end of life last buy date for the part will occur prior to the end of the life of the design in which it is being used.

DUP. This column indicates with a check mark that bill of material assist identified more than one or duplicate local part numbers in the commercial database for the supplier name and supplier part number originally provided.

Part number. This column contains the local part number.

Description. This column contains the part description as originally provided by the user.

Leaf Class. This column contains the Aspect (TM) leaf class description of the part (commodity type), where an enterprise is utilizing the Aspect Explore (TM) database.

Message. If a part has a message in the commercial database, it is reflected here. For example, whether a part is preferred or should not be used.

Although not specifically shown in FIG. 4, the following fields of information are also provided in screen 400.

Supplier name. This field contains the name of the supplier that manufactures the part.

Supplier part number. This field contains the part number used by the supplier to identify the part.

Alternative local part number. This field contains a recommended alternative local part number to be used in lieu of the original local part number requested.

Quantity. This column indicates the quantity of the part used in this design.

Data Provider. This field indicates the organization that owns the part and is responsible for providing the parametric data for the part into the commercial database.

Engineering Change. This column indicates the engineering change number associated with the local part number.

Engineering Status. This column entry contains the engineering status code for the part where, for example, A=Active, O=Obsolete, J=field use only, etc.

Preferredness. This column indicates whether the part is designated as preferred in the commercial database.

Technical Usage Code (TUC). This column contains the technical usage code for the part.

Engineer name. This column indicates the name of the engineer responsible for the commercial data content of the park.

Supply Status. This column indicates whether the supply of this part is currently constrained or on allocation.

Restricted Usage Code. This column indicates the restricted usage code (RUC) for the part.

End of Life (EOL) Last Buy Date. This column indicates the last buy date for a part which the supplier has identified as going end of life.

Lead time (worst). This column contains the lead time in days for obtaining the part in manufacturing quantities. For parts sourced from more than one supplier, the lead time identified will be for the worst case supplier.

Part Sourcing Status. This column indicates whether the part is single-sourced or has multiple qualified sources.

Reference Designators. This column indicates where the part is located on a Card.

Other Column. The input file to bill of material assist application may have columns of data that a user wants to include in a quick check, that is not needed by BRS. This column may have information like shape type and comments. It provides a flexible feature allowing a user to define new requirements or specific instances and provide associated content as desired.

Commodity. This column is data to allow BRS to place new parts request in the right bucket for review.

If the results of the Quick Check execution are not satisfactory, the bill of material assist application allows the designer to modify the BOM list at step 210 and revert back to the beginning of the selection process at step 200. If the results are satisfactory, the Quick Check process continues at step 212 where the designer generates an Approved Vendor List (AVL) in order to indicate to contract manufacturing or internal manufacturing a complete and valid listing of approved sources for each specific part number. For example, at step 214 the bill of material assist application compares the current BOM data with outside sources such as Aspect Explore (TM) database for alternative selections. This capability allows a designer to view an expansive list of comparable parts provided by outside vendors along with pertinent information such as availability, end-of-life dates, and preferredness ratings as shown further in Isample window screen 400 of FIG. 4. If the designer notes that parts provided from outside sources are preferable to what has been entered in the original BOM list, he/she then modifies the BOM list accordingly at step 210. The selection and design creation process begins once again at step 200.

Information provided in the AVL screen include the following fields of data.

DUP. This column indicates with a check mark that this local part number is one of two or more possible part numbers which match the supplier name and supplier part number originally provided.

Part number. This column indicates the local part number for the part.

Quantity. This column indicates the quantity of the part used in this design bill of materials.

Description. This column contains the part description as provided by the user.

Supplier Name. This column contains the names of the approved suppliers (AVL) for the local part number.

Supplier Part Number. This column contains the part number used by the supplier to identify the part.

Data Provider. This column indicates the internal source for the part.

Local part number commercial database description. This column contains the description of the part as found in the commercial database.

Part Type. This column entry contains a description of the commercial database part type classification category.

Technical Purchase Status. This column entry indicates whether or not the supplier named on that entry is currently approved as a source of the part.

Qualification Status. This column entry indicates the qualification status of the part from the specific supplier source listed on that line.

Reference designators. This column indicates where the part is located on a Card.

Parent Part Number. On import the user will select “parent part number” as part of the input profile. This data is used to export to A-Source to set up a hierarchy BOM in A-Source.

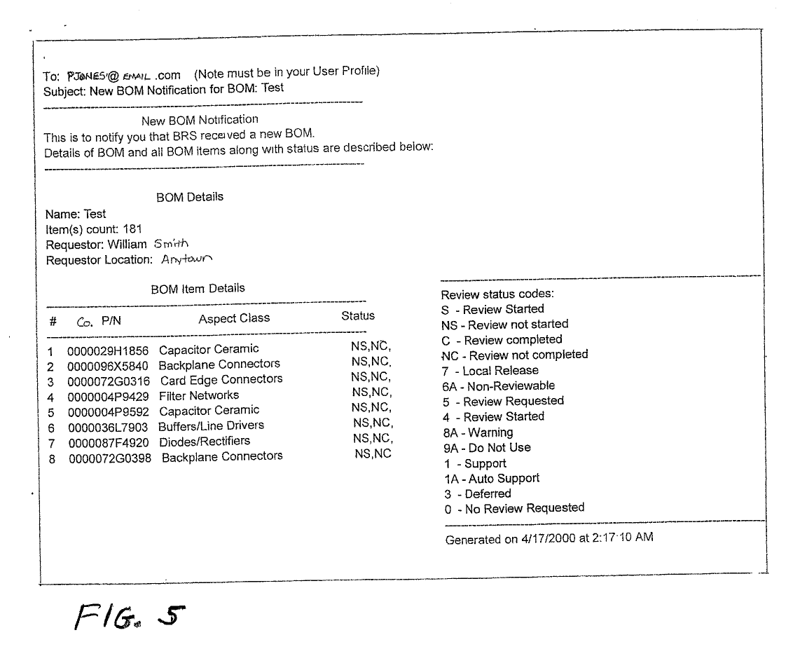

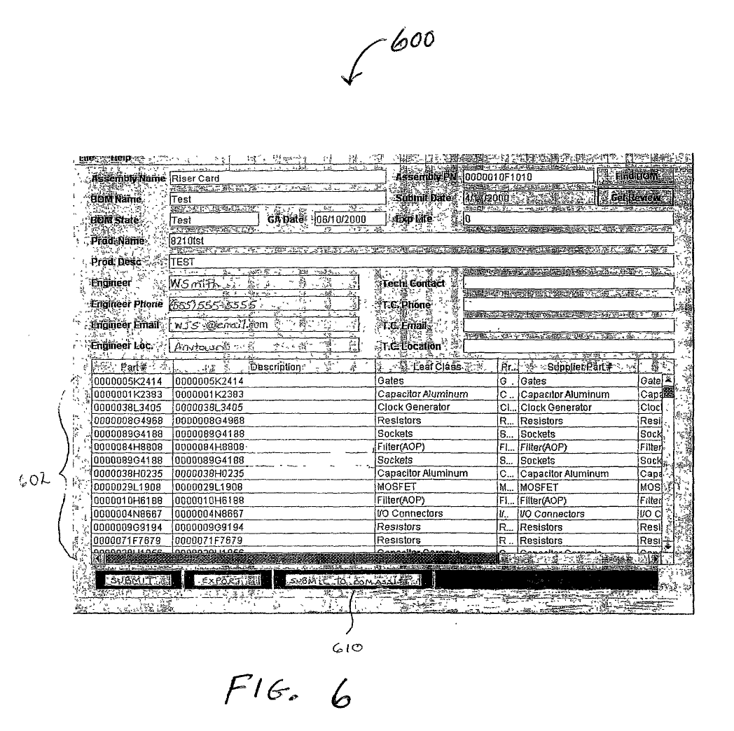

If the results of the Quick Check analysis are satisfactory, then the designer submits the BOM to a bill of materials review system (BRS) for review by the procurement team at step 216. The bill of material review system is an application used by development personnel to obtain support from procurement for new part requests. If suitable software similar to BRS is not available to enterprise 101, this information may alternatively be manually transmitted to procurement personnel for review. BRS is alerted of the new DOM via the bill of material assist application which in cooperation with Lotus Notes (TM) generates and transmits a notification to procurement as shown generally in FIG. 5. Once delivered to BRS, flow proceeds to FIG. 2B whereby the procurement team reviews the BRS input and sends a response at step 218. This is done by selecting the “submit to bill of material assist” item 610 on window screen 600 of FIG. 6. The designer then reviews the reply sent by procurement via the BRS system at step 220, a sample of which is shown in FIG. 6. A designer can view comments made by BRS regarding a particular part number by ‘right clicking’ on the desired part number line shown collectively at 602. If the comments reveal that BRS requires additional information, this information may be provided by the designer via the BRS system, followed by resubmission of the updated file at step 222. The process then reverts back to step 218 for additional review by procurement. If changes are required to be made to the BOM, flow reverts back to step 200 for redesign and regeneration of a new bill of materials. If the results of the review are satisfactory, the designer then imports the BOM from the BRS system into the bill of material assist application at step 224 for additional processing. The designer again executes the Quick Check tool at step 226 as described above, followed by an approved vendor analysis at step 228. Once completed, the designer releases the final BOM for production at step 230.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for managing parts requirements processes in an engineering environment, comprising:
an enterprise system including:
a workstation;
a server;
a network connection for allowing said workstation and said server to communicate; and
a storage device coupled to said workstation;
wherein said enterprise system is executing a bill of material assist application for managing said parts requirements processes.

2. The system of claim 1, further comprising:
a database of parts information.

3. The system of claim 1, further comprising:
a database of procurement information.

4. The system of claim 1, further comprising:
a database of computer aided drafting information.

5. The system of claim 1, further comprising:
a database of approved vendors lists.

6. The system of claim 1, further comprising:
a database of bill of material files.

7. The system of claim 2, wherein said database of parts information is commercially provided, and wherein said database of parts information is accessible to said enterprise system by a communications link.

8. The system of claim 3, wherein said database of procurement information is commercially provided, and wherein said database of procurement information is accessible to said enterprise system by a communications link.

9. The system of claim 4, wherein said database of computer aided drafting information is commercially provided, and wherein said database of computer aided drafting information is accessible to said enterprise system by a communications link.

10. A method for managing parts requirements processes in an engineering environment via a bill of material assist application, comprising:
importing component parts data listed on a bill of material to said bill of material assist application;
mapping said component parts data to associated data fields provided by said bill of material assist application;
aggregating information from a plurality of sources and correlating said information to said components parts data; and
providing results of said correlating said information in a summary form to a user of said bill of material assist application.

11. The method of claim 10, further comprising modifying said component parts data on said bill of material by said user in response to reviewing said results of said correlating said information.

12. The method of claim 10, further comprising:
generating an approved vendor list indicating approved sources of component supply for items on said bill of material; and
comparing approved vendors on said approved vendor list for alternative sources of said component supply.

13. The method of claim 12, further comprising modifying said bill of material list based upon said comparing.

14. The method of claim 10, further comprising transferring said bill of material list to relevant entities for review or approval.

15. The method of claim 14, further comprising modifying said bill of material list based upon said review or said approval.

16. The method of claim 10, further comprising:
transferring said bill of material list to said user; and
transferring said bill of material list to at least one of said relevant entities.

17. The method of claim 10, wherein said importing said component parts data to said bill of material assist application is performed manually by said user.

18. The method of claim 10, wherein said importing said component parts data to said bill of material assist application is performed electronically via said bill of material assist application whereby said component parts data is stored in a database accessed by said user.

19. The method of claim 10, wherein said plurality of sources include:
at least one parts database;
at least one procurement database;
at least one computer aided drafting database;
at least one approved vendors database; and
external supplier databases.

20. The method of claim 10, wherein said aggregating information includes data pertaining to:
lead time;
currently supply status;
single or multiple source;
end of life date; and
preferredness rating.

21. The method of claim 20, further comprising data pertaining to:
map flags;
life cycles;
duplicate local part numbers;
local part numbers;
part descriptions;
leaf class description;
messages;
supplier names;
supplier part numbers;
alternative local part numbers;
quantities;
data providers;
engineering changes;
engineering statuses;
technical usage codes;
engineers names;
supply statuses;
restricted usage codes;
end of life dates;
lead times;
part sourcing statuses;
reference designators;
commodities; and
comments desired by a system user.

22. A storage medium encoded with machine-readable computer program code for managing parts requirements processes in an engineering environment via a bill of material assist application, the storage medium including instructions for causing a computer to implement a method comprising:
importing component parts data listed on a bill of material to said bill of material assist application;
mapping said component parts data to associated data fields provided by said bill of material assist application;
aggregating information from a plurality of sources and correlating said information to said components parts data; and
providing results of said correlating said information in a summary form to a user of said bill of material assist application.

23. The storage medium of claim 22, further comprising instructions for causing a computer to implement:
modifying said component parts data on said bill of material by said user in response to reviewing said results of said correlating said information.

24. The storage medium of claim 22, further comprising instructions for causing a computer to implement:
generating an approved vendor list indicating approved sources of component supply for items on said bill of material; and
comparing approved vendors on said approved vendor list for alternative sources of said component supply.

25. The storage medium of claim 24, further comprising instructions for causing a computer to implement:
modifying said bill of material list based upon said comparing.

26. The storage medium of claim 22, further comprising instructions for causing a computer to implement:
transferring said bill of material list to relevant entities for review or approval.

27. The storage medium of claim 26, further comprising instructions for causing a computer to implement:
modifying said bill of material list based upon said review or said approval.

28. The storage medium of claim 22, further comprising instructions for causing a computer to implement:
transferring said bill of material list to said user; and
transferring said bill of material list to at least one of said relevant entities.

29. The storage medium of claim 22, wherein said importing said component parts data to said bill of material assist application is performed manually by said user.

30. The storage medium of claim 22, wherein said importing said component parts data to said bill of material assist application is performed electronically via said bill of material assist application whereby said component parts data is stored in a database accessed by said user.

31. The storage medium of claim 22, wherein said plurality of sources include:
at least one parts database;
at least one procurement database;
at least one computer aided drafting database;
at least one approved vendors database; and
external supplier databases.

32. The storage medium of claim 22, wherein said aggregating information includes data pertaining to:
lead time;
currently supply status;
single or multiple source;
end of life date; and
preferredness rating.

33. The storage medium of claim 22, further comprising instructions for causing a computer to implement providing data pertaining to:
map flags;
life cycles;
duplicate local part numbers;
local part numbers;
part descriptions;
leaf class description;
messages;
supplier names;
supplier part numbers;
alternative local part numbers;
quantities;
data providers;
engineering changes;
engineering statuses;
technical usage codes;
engineers names;
supply statuses;
restricted usage codes;
end of life dates;
lead times;
part sourcing statuses;
reference designators;
commodities; and
comments desired by a system user.
